(19) United States
(12) Patent Application Publication
(10) Pub. No.: US 2024/0312697 A1
(43) Pub. Date: Sep. 19, 2024

(54) COIL COMPONENT

(71) Applicant: TAIYO YUDEN CO., LTD., Tokyo (JP)

(72) Inventors: Toshimasa SUZUKI, Tokyo (JP); Daiki MIMURA, Tokyo (JP); Tomoo KASHIWA, Tokyo (JP)

(73) Assignee: TAIYO YUDEN CO., LTD., Tokyo (JP)

(21) Appl. No.: 18/606,190

(22) Filed: Mar. 15, 2024

(30) Foreign Application Priority Data
Mar. 16, 2023 (JP) 2023-041693

(51) Int. Cl. H01F 27/29

(52) U.S. Cl. CPC H01F 27/292

(57) ABSTRACT

A coil component includes a magnetic base body including magnetic metal particles and resin; a conductor disposed inside or on a face of the magnetic base body; and external electrodes disposed on a first face of the magnetic base body and connected with the conductor. Each external electrode has a central portion and a peripheral portion disposed adjacent to the central portion. The central portion has a contact surface that is in contact with the first face and an exterior surface that is opposite to the contact surface, and the peripheral portion has a contact surface that is in contact with the first face and an exterior surface that is opposite to the contact surface. The distance from the first surface to the exterior surface of the peripheral portion is less than the distance from the first surface to the exterior surface of the central portion.

### TECHNICAL FIELD

The present invention relates to coil components.

### BACKGROUND ART

Conventionally, mobile phones are known as typical high-performance electronic devices. Electronic components used in mobile phones are needed not only to have higher performance but also to be smaller. In addition, some electronic devices need a greater number of components, so that high-density mounting, in which components are mounted at a high density, is used. To achieve high-density mounting, components should be smaller and the pitch between them should be narrower.

In designing electronic components with narrower component spacing, a structure in which external electrodes are provided only on a single mounting surface is often adopted, and technical studies on this structure have been developed in the past.

For example, Patent Document 1 discloses a surface-mount inductor with a bottom electrode structure in which two external electrodes are provided to an element body in such a manner that each external electrode is mounted on an end face and end portions of the top face, bottom face, and side faces, and in which the faces, except for the bottom face, are covered with an insulating resin. The technology of Document 1 can reliably expose only the bottom face by a relatively easy method.

For example, Patent Document 2 discloses a coil component in which a Ni—Cu—Zn ferrite is used for a magnetic material. However, there is a technological trend to use a magnetic metal material for the magnetic material instead of ferrite in order to achieve higher performance in small coil components.

### BACKGROUND DOCUMENT(S)

### Patent Document(s)

Patent Document 1: JP 2016-201466 A
Patent document 2: JP 2015-39026 A

### SUMMARY OF THE INVENTION

However, in the technology of Patent Document 1, the insulating resin should have a sufficient thickness to ensure insulation and it is necessary to prevent adhesion of the insulating resin to the electrodes on the bottom face. Therefore, miniaturization of electronic components is limited, and high-density mounting is also limited.

In coil components in which a magnetic metal material is used, the weight of the insulator layer is approximately 1.5 times greater than that in coil components with the same volume in which ferrite is used. Therefore, there is a demand for ensuring mounting strength even for small coil components with a small electrode area for high-density mounting.

Accordingly, the present invention provides a coil component in which a magnetic metal material is used, and high-density mounting is enabled.

According to one aspect of the present invention, there is provided a coil component including a magnetic base body including magnetic metal particles and resin; a conductor disposed inside or on a face of the magnetic base body; and external electrodes disposed on a first face of the magnetic base body and connected with the conductor. Each external electrode has a central portion and a peripheral portion disposed adjacent to the central portion. The central portion has a contact surface that is in contact with the first face and an exterior surface that is opposite to the contact surface, and the peripheral portion has a contact surface that is in contact with the first face and an exterior surface that is opposite to the contact surface. The distance from the first surface to the exterior surface of the peripheral portion is less than the distance from the first surface to the exterior surface of the central portion.

The peripheral portion may surround the central portion in each of the external electrodes.

The central portion may have multiple layers stacked one on top of another, and the peripheral portion may have multiple layers stacked one on top of another. The number of layers in the central portion may be greater than the number of layers in the peripheral portion in each of the external electrodes.

Each of the external electrodes may have a metal layer commonly provided to the exterior surfaces of the central portion and the peripheral portion, and the central portion may have a resin layer between the metal layer and the first face in each of the external electrodes.

The external electrodes may be located within the area of the first face.

The exterior surface of the peripheral portion may have a surface roughness that is greater than a surface roughness of the exterior surface of the central portion in each of the external electrodes.

According to an aspect of the present invention, there is provided a circuit board arrangement that includes the above-descried coil component and a substrate on which the coil component is mounted.

The present invention provides a coil component in which a magnetic metal material is used, and high-density mounting is enabled.

### BRIEF DESCRIPTION OF THE DRAWINGS

With reference to the accompanying drawings, various embodiments of the present invention will be described hereinafter. In the drawings:

FIG. 1 is a perspective view showing a coil component according to a first embodiment of the present invention;

FIG. 2 is a cross-sectional view of the coil component according to the first embodiment of the present invention;

FIG. 3 is a bottom view of the coil component according to the first embodiment;

FIG. 4 is an enlarged view of a part of the coil component including an external electrode;

FIG. 5 is a schematic enlarged view showing a microscopic structure of the external electrode;

FIG. 6 is a bottom view of a coil component according to a second embodiment of the present invention;

FIG. 7 is a bottom view of a coil component according to a third embodiment of the present invention; and

FIG. 8 is a bottom view of a coil component according to a fourth embodiment of the present invention.

### DESCRIPTION OF EMBODIMENTS

The following embodiments are not intended to limit the present invention, and not all of features in the embodiments are essential for the present invention. The embodiments may be modified or changed as appropriate depending on specifications of the devices to which the present invention is applied and conditions (conditions of use, environment of use, etc.).

The technical scope of the present invention is defined by the accompanying claims and is not limited by the following individual embodiments. The accompanying drawings used for the following description may differ in scale and shape from the actual structure for easy understanding of the embodiments. In the drawings, the same reference symbols will be used for identifying the same or similar components.

### First Embodiment

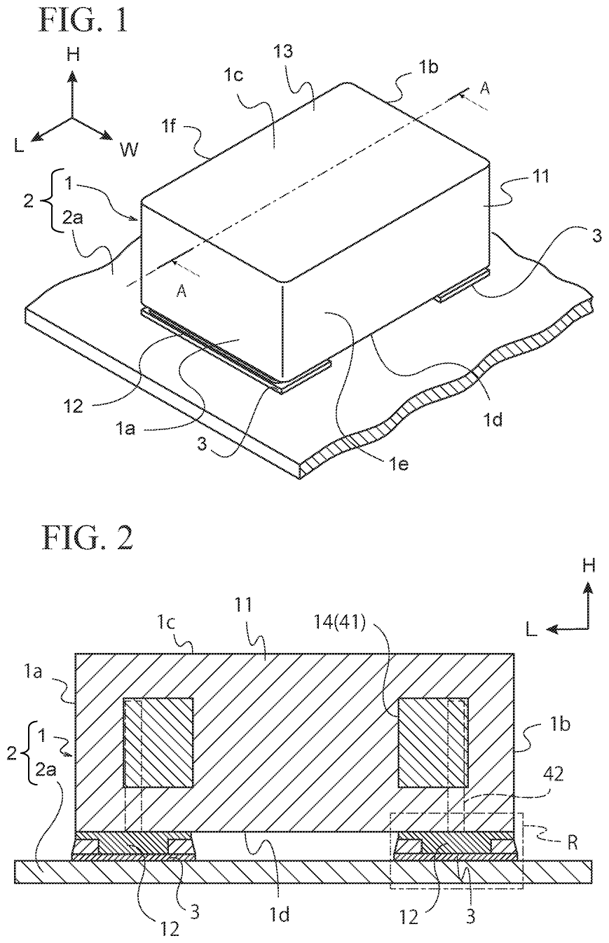

FIGS. 1 and 2 show a coil component according to a first embodiment of the present invention. FIG. 2 shows a cross-section taken along line A-A in FIG. 1.

The coil component 1 is mounted on a substrate 2a. The substrate 2a is provided with, for example, two bonding pads or lands 3. The coil component 1 has a single magnetic base body 11 and two external electrodes 12. The coil component 1 is mounted on the substrate 2a by soldering external electrodes 12 to the lands 3, respectively. When viewed along the H-axis direction, the area of each land 3 is equal to or less than 1.6 times the area of each external electrode 12. More preferably, when viewed along the H-axis direction, the area of each land 3 is equal to or less than 1.3 times the area of each external electrode 12.

A circuit board arrangement 2 according to an embodiment of the present invention includes the coil component 1 and the substrate 2a on which the coil component 1 is mounted. Such a circuit board arrangement 2 is provided in various electronic devices including automotive electrical components, servers, single-board computers, and various other electronic devices.

The coil component 1 may be used for an inductor, a filter, a reactor, etc. in various usages. The inductor component 1 may be used for a coupled inductor, a transformer, a choke coil, or another various magnetically coupled inductor component. For example, the inductor component 1 may be used for an inductor in a DC/DC converter.

In this specification, unless otherwise understood from context, directions are based on the L-axis, W-axis, and H-axis in FIG. 1, and are referred to as the length direction, width direction, and height direction.

The coil component 1 has a rectangular parallelepiped contour. That is, the coil component 1 has end faces 1a and 1b at both ends in the length direction L, a top face 1c and a bottom face 1d at both ends in the height direction H, and a front face 1e and a rear face 1f at both ends in the width direction W. The bottom face 1d is a mounting surface that faces the substrate 2a when the coil component 1 is mounted on the substrate 2a.

The maximum length of the rectangular parallelepiped coil component 1 (in the length direction L) is less than 5.0 mm or less than 2.5 mm, and may be even less than 2.0 mm. The total area of the external electrodes 12 is less than 20% of the surface area of the coil component 1, and may be even less than 10% of the surface area of the coil component 1. The weight per unit volume of the coil component 1 is greater than 0.0060 g/mm³ or greater than 0.0065 g/mm³, and may be even greater than 0.0070 g/mm³.

Some of the faces of the coil component 1 may be flat or curved. In addition, some of the eight vertices and twelve edges of the coil component 1 may be rounded or chamfered.

In this specification, even if some of the faces of the coil component 1 are curved or even if some of vertices and edges are rounded or chamfered, the contour of the coil component 1 may be referred to as a “rectangular parallelepiped.” In other words, the term “rectangular parallelepiped” used herein does not necessarily mean a rectangular parallelepiped in the strict mathematical sense.

### Structure of Coil Component

In the first embodiment of the present invention, the coil component 1 has the magnetic base body 11, the external electrodes 12, and a coil conductor 14 within the magnetic base body 11.

The magnetic base body 11 has a rectangular parallelepiped shape having end faces, a top face, a bottom face, a front face, and a rear face that are substantially the same as the end faces 1a and 1b, the top face 1c, the bottom face 1d, the front face 1e, and the rear face 1f of the coil component 1.

The magnetic base body 11 in the first embodiment is a magnetic body formed from a magnetic metal material and a binder. The binder bonds particles of the magnetic metal material and is an insulating material with a high level of electric insulation to prevent electrical conduction. By virtue of the binder, the surface resistance of the magnetic base body 11 is 10⁵ Ω/sq. or higher. It is desirable that the composition and the blending ratio of the binder be adjusted so as to be suitable for the magnetic metal material. For example, in a case in which the magnetic metal material contains Fe as the main component, the magnetic metal material per se has low electrical resistance, so that the composition and the blending ratio of the binder may be adjusted to be suitable for the electrical resistance of Fe. For example, a binder with a specific electrical resistance of 10⁸ Ωcm or higher is selected as the binder. For the purpose of improving electrical insulation, the binder may include a resin, and glass and metal oxides may be selected as components added in the resin.

The magnetic base body 11 has an extremely high specific electrical resistance inside thereof. In addition, since the binder exists on the surfaces of the magnetic base body 11, the surfaces also have an extremely high specific electrical resistance. The particles of the magnetic metal material are particles of one or more of Fe, Ni, and Co. In addition to magnetic metal particles, the magnetic metal material may also contain ceramic magnetic particles of one or more of Mg, Mn, and Ni and/or non-magnetic particles such as silica particles. The magnetic metal particles may also include particles of one or more of Si, Cr, Al, B, and P in addition to Fe, Ni, and Co particles, or may be a combination of multiple types of magnetic metal particles.

The particles of the magnetic metal material have a particle size of 1 μm to 60 μm. If the magnetic metal material further includes other particles such as metal fine particles, metal oxide particles, ceramic particles, etc. in addition to the magnetic metal particles, the average particle size of the other particles is less than the particle size of the particles of the magnetic metal material, and is, for example, 0.01 to 1 μm. The other particles may be used to reduce voids or compensate for mechanical strength rather than to enhance the magnetic quality.

In the magnetic base body 11, the filling rate of the of magnetic metal material is from 80 vol. % to 88 vol. % and the remainder consists of non-magnetic metal materials that may include one or more insulators and/or voids.

The coil conductor 14 is made from a metallic material with excellent electrical conductivity. For example, one or more of Cu, Al, Ni, or Ag, or an alloy including any of these metals can be used for the metallic material for the coil conductor 14. The coil conductor 14 may be a wound metal conductive wire having an insulating film on the peripheral surface thereof, or formed by plating or printing on the surface of one or more substrates, sheets, etc.

The coil conductor 14 in the embodiment has a loop section 41 that has one or more turns. The number of turns of the loop section 41 is, for example, from 1.5 to 10.5. When the length of the coil component 1 in the length direction L is, for example, from 1.0 mm to 2.5 mm, the number of turns of the loop section 41 is, for example, equal to or greater than 1.5 and is equal to or less than 6.5. The shape of the loop section 41 may be flat or spiral. The loop section 41 may, for example, be a single combination that has multiple turns in which an upper turn and a neighboring lower turn are overlapped with each other. Furthermore, the coil conductor 14 may have an imperfect loop shape constituted of straight portions or may have a shape resembling stairs.

The coil conductor 14 may be divided into multiple coil elements. The term “multiple coil elements” means that the elements are electrically insulated with each other and each element functions as a coil. A coil component 1 in which the coil conductor 14 is divided into multiple coil elements includes, for example, an array type in which the coil elements are arranged in parallel, and a type in which the coil elements are magnetically coupled to each other. The coil component 1 in which the coil conductor 14 is divided into multiple coil elements is, specifically, a transformer, a common mode choke coil, a coupled inductor, etc.

The coil conductor 14 has connection terminals 42 for electrical connection with outside elements. The connection terminals 42 are disposed at both ends of the loop section 41 and are connected with the external electrodes 12, respectively. The scheme for forming the coil conductor 14 is not limited and may be any of winding, thin-film forming, or a lamination process.

FIG. 2 illustrates a horizontally wound loop section 41 in which the conductor is wound along the bottom face 1d and the top face 1c of the magnetic base body 11. However, the coil conductor 14 may have a vertically wound loop section in which the conductor is wound along the end faces 1a and 1b of the magnetic base body 11.

The coil component 1 includes at least a pair of external electrodes 12 disposed on the bottom face 1d, which corresponds to a first face of the magnetic base body 11. In this specification, the term “disposed on a face” or “provided on a face” means that they can be seen when looking at the face and that the face may be constituted of two planes or may include a curved surface. Accordingly, even if the external electrodes 12 protrude from the face or even if the external electrodes 12 cover protrusions formed on the face, the fact remains that the external electrodes 12 are “disposed on the face” or “provided on a face.”

The external electrodes 12 are formed from a common metallic material, for example, Ag, Cu, Ti, Cr, Ni, or Sn, or a combination containing at least two of these materials. For example, each external electrode 12 has a single metal layer having a thickness of 0.01 μm to 5 μm. Alternatively, each external electrode 12 may be a combination of multiple metal layers having a total thickness of 5 μm to 10 μm. Each external electrode 12 may be partially combined with an electroconductive resin layer containing a resin, and may have a total thickness of 10 μm to 30 μm in this case. The content ratio of the resin in the electroconductive resin layer is greater than 10 vol. % and is less than 60 vol. %. It is preferable that the electrical resistance of the electroconductive resin layer be at least 10 times that of the metal layer.

The coil component 1 is manufactured, for example, through a molding process and a machining process. More specifically, in the molding process, a molded body, which becomes the magnetic base body 11, is formed by, for example, powder compacting, sheet forming, or mold forming. The coil conductor 14 is formed, for example, by being integrated with the molded body (magnetic base body 11) in the molding process. Alternatively, the coil conductor 14 may be formed prior to the molding process and integrated with the molded body in the molding process.

The external electrodes 12 are provided on the first face (i.e., the bottom face 1d) formed by the machining process in which part of the molded body is machined. The machining process is a process to expose the end surfaces of the connection terminals 42 of the coil conductor 14 by grinding and/or cutting. A precursor of each external electrode 12 is disposed within the area of the bottom face 1d and each external electrode 12 is formed by electroplating on the precursor. The precursor may be formed by sputtering, vapor deposition, or electroless plating of a metallic material. Alternatively, the precursor may be formed by printing or coating of an electroconductive resin material.

### Structure of External Electrode

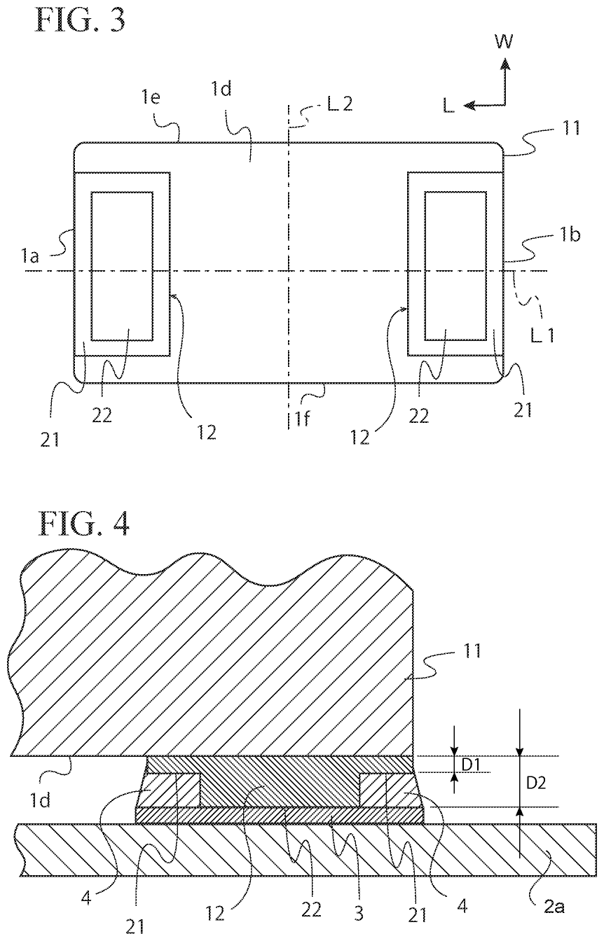

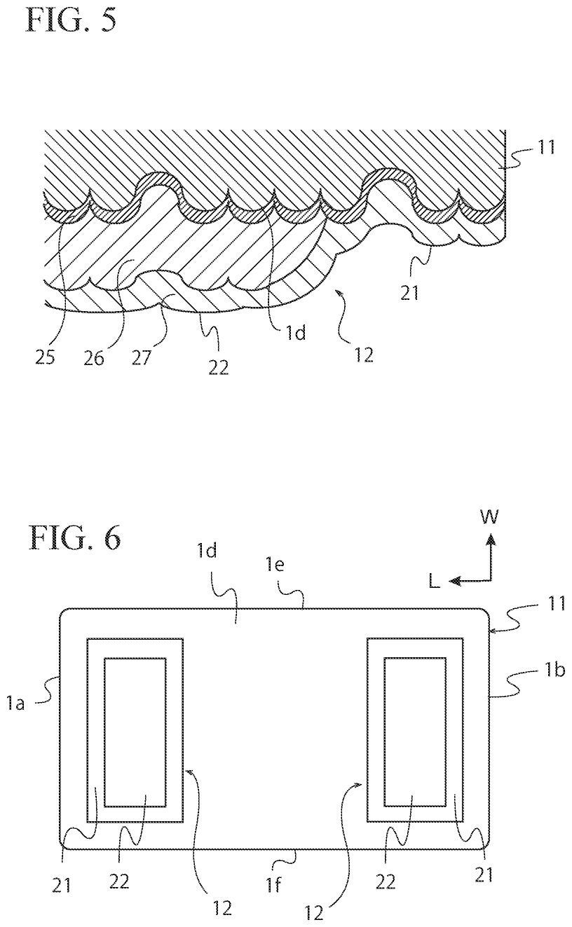

The structure of the external electrodes 12 will be described in more detail with reference to FIGS. 3 to 5. FIG. 3 shows the bottom of the coil component 1. FIG. 4 shows an enlarged view of an area corresponding to a region R in FIG. 2. FIG. 5 schematically shows a microscopic structure of the external electrode 12.

Each external electrode 12 has an area that is suitable for the external dimensions of the coil component 1, in particular, for the dimensions of the bottom face 1d. In addition, the area of external electrode 12 should be suitable for mounting on the substrate 2a. For example, the total area of the external electrodes 12 is equal to or less than 80% of the area of the bottom face 1d. Since a pair of external electrodes 12 are provided in the embodiment, the area of each external electrode 12 is less than 40% of the area of the bottom face 1d.

Each external electrode 12 is located within the area of the bottom face 1d and do not project from the corresponding end face 1a or 1b, the front face 1e, or the rear face 1f. Therefore, expansion of the dimensions of the coil component 1 caused by the presence of the external electrodes 12 is prevented in the L-W plane, and the magnetic base body 11 can be maximized. In a case in which the sizes of the external electrodes 12 are maximized within the bottom face 1d, the sides of each external electrode 12 may be flush with the corresponding end face 1a or 1b, the front face 1e, and the rear face 1f. Even in this case, the external electrodes 12 do not expand the dimensions of the coil component 1 in the L-W plane.

As best shown in FIG. 3, each external electrode 12 has a peripheral portion 21 and a central portion 22, in which the peripheral portion 21 is located outside the central portion 22 when viewing the bottom face 1d. In each external electrode 12 of the embodiment, the peripheral portion 21 surrounds the central portion 22. The central portion 22 includes the exact center of the external electrode 12, whereas the peripheral portion 21 does not include the exact center of the external electrode 12 and includes at least a portion of the periphery of the external electrode 12.

Within the bottom face 1d of each external electrode 12, the central portion 22 has an area that is greater than that of the peripheral portion 21. In each external electrode 12, the area of the central portion 22 relative to that of the bottom face 1d of the magnetic base body 11 is greater than 50% and equal to or less than 90%, and the area of the peripheral portion 21 relative to that of the bottom face 1d of the magnetic base body 11 is less than 50% and equal to or greater than 10%. Preferably, the area of the central portion 22 relative to that of the bottom face 1d of the magnetic base body 11 is greater than 60% and equal to or less than 80%, and the area of the peripheral portion 21 relative to that of the bottom face 1d of the magnetic base body 11 is less than 40% and equal to or greater than 20%. Since the area of the central portion 22 is greater than that of the peripheral portion 21, the posture of the coil component 1 before and during mounting of the coil component 1 is stabilized.

The width of the peripheral portion 21 (the distance between the outer edge of the peripheral portion 21 and the outer edge of the central portion 22) is at least three times the diameter of the magnetic metal particles of the magnetic base body 11. If the width of the peripheral portion 21 is less than three times the diameter of the magnetic metal particles, the benefit in the mounting strength obtained by the peripheral portion 21 may be reduced.

In the embodiment, a pair of external electrodes 12 are provided, and the central portions 22 and peripheral portions 21 of the pair of external electrodes 12 are in a symmetrical positional relationship. That is, the central portions 22 are symmetrical with respect to a symmetry axis L1 extending in the L direction. The same is true for the peripheral portions 21. The central portions 22 and peripheral portions 21 are also arranged symmetrically with respect to a symmetry axis L2 extending in the W direction. Since the central portion 22 and the peripheral portion 21 are arranged in this way, a self-alignment effect can be obtained that increases the positional accuracy of coil component 1 during mounting on the substrate 2a.

As best shown in FIG. 4, the central portion 22 has a contact surface that is in contact with the bottom face 1d and a remote surface (i.e., an exterior surface) that is opposite to the contact surface, and the peripheral portion 21 also has a contact surface that is in contact with the bottom face 1d and a remote surface (i.e., an exterior surface) that is opposite to the contact surface. The thickness of the peripheral portion 21 is less than that of the central portion 22, so that the distance D1 from the bottom face 1d of the coil component 1 to the exterior surface of the peripheral portion 21 is less than the distance D2 from the bottom face 1d to the exterior surface of the central portion 22. Accordingly, there is provided a step between the exterior surface of the peripheral portion 21 and the exterior surface of the central portion 22 due to the difference in thickness. For this reason, when the coil component 1 is mounted on the substrate 2a, a circumferential recess is provided between the land 3 and the peripheral portion 21 in which a solder fillet 4 is placed. The outer surface of the solder fillet 4 is inclined at an angle greater than 45 degrees relative to the surface of substrate 2a. Furthermore, the angle of inclination of the outer surface of solder fillet 4 can be formed within a range of greater than 60 degrees and less than 90 degrees relative to the surface of the substrate 2a. As a result, protrusion of the solder fillet 4 from the outer periphery of the bottom face 1d is minimized, and high-density mounting of the coil component 1 is enabled.

The thickness of central portion 22 is representative of the thickness of the external electrodes 12.

In a case in which the distance D1 from the bottom face 1d of the coil component 1 to the exterior surface of the peripheral portion 21 is less than 10 μm, even if one end of the peripheral portion 21 is flush with the corresponding end face 1a or 1b, the solder for mounting the coil component 1 on the substrate 2a is prevented from protruding outward from the corresponding end face 1a or 1b. This is because less solder adheres to the peripheral portion 21, and a force that causes the solder to spread outward is less than the surface tension that causes the solder to stay in the region between the peripheral portion 21 and the substrate 2a.

Each external electrode 12 is formed by laminating multiple layers, and the number of layers in the central portion 22 is greater than that in the peripheral portion 21. Specifically, for example, the central portion 22 has three or more layers, whereas the peripheral portion 21 has two or more layers. As best shown in FIG. 5, the central portion 22 may include a resin layer 26 formed from an electroconductive resin material, and a metal layer 27 that covers the resin layer 26 to form the exterior surface. On the other hand, the peripheral portion 21 does not include the resin layer 26, and the exterior surface of the peripheral portion 21 has the metal layer 27 that is continuous from the exterior surface of the central portion 22. The difference in thickness of the metal layer 27 between the central portion 22 and the peripheral portion 21 is within 10%. As a result, change in resistance between the central portion 22 and the peripheral portion 21 of each external electrodes 12 is minimized, and when a current is applied to the external electrodes 12, concentration of heat generation in external electrodes 12 is reduced.

Each external electrode 12 may have a metal film 25 as a part thereof. The metal film 25 is brought into contact with the bottom face 1d. The thickness of the metal film 25 is less than those of the resin layer 26 and the metal layer 27. In a case in which the thickness of the metal film 25 is less than 1 μm, the metal film 25 may be formed as a continuous single membrane, or may be formed as multiple membranes scattered on the bottom face 1d. The metal film 25 may also include a continuous membrane and multiple smaller membranes.

In a case in which the central portion 22 has the resin layer 26, the thickness of the resin layer 26 is preferably greater than that of the metal layer 27. In this case, the resin layer 26 significantly relieves the stress exerted in the corresponding external electrode 12. On the other hand, the peripheral portion 21 does not have the resin layer 26 and is composed of the metal film 25 and the metal layer 27, so that the peripheral portion 21 has a high mechanical strength to enhance the durability of both the peripheral portion 21 and the central portion 22.

Each portion of each external electrode 12 has a number of layers and a necessary thickness that are suitable for the surface roughness of the bottom face 1d of the magnetic base body 11. However, each external electrode 12 is preferably thinner. For example, the thickness of the thinnest part in the peripheral portion 21 is 4 μm or more, and the thickness of the thickest part in the central portion 22 is 30 μm or less. In addition, in each external electrode 12, the surface roughness of the exterior surface of the peripheral portion 21 is greater than that of the exterior surface of the central portion 22. As a result, the peripheral portion 21 has a greater contact area with the solder for mounting the coil component 1 on the substrate 2a, and can increase the bonding strength with the solder.

For example, the central portion 22 is formed with a thickness to ensure that it is less than 50% of the surface roughness of bottom face 1d (arithmetical mean height Sa in accordance with ISO 25178), and the peripheral portion 22 is formed with a thickness to ensure that it is greater than 50% of the surface roughness of bottom face 1d. The surface roughness of the exterior surface of the peripheral portion 21 and the surface roughness of the exterior surface of the central portion 22 are adjusted so that the surface roughness of the exterior surface of the peripheral portion 21 is greater than that of the exterior surface of the central portion 22. The surface roughness of the exterior surface of the peripheral portion 21 and the surface roughness of the exterior surface of the central portion 22 are greater when the surface roughness of the magnetic base body 11 is greater, and are less when the number of layers and the thickness are greater. Therefore, the peripheral portion 21 has fewer layers and a less thickness in comparison with the central portion 22.

In order to reduce the size of the coil component 1, the arithmetic mean height Sa of the bottom face 1d of the magnetic base body 11 is 5 μm or less. For example, in a case in which the arithmetic mean height Sa of the bottom face 1d of the magnetic base body 11 is greater than 2 μm, and if the thickness of the peripheral portion 21 is 10 μm or less, the arithmetic mean height Sa of the peripheral portion 21 is less than that of the bottom face 1d and 2 μm or more.

On the other hand, the central portion 22 has a less surface roughness than that of the peripheral portion 21 since it has more layers or a greater thickness in comparison with the peripheral portion 21. For example, even if the arithmetic mean height Sa of the bottom face 1d of magnetic base body is greater than 2 μm, if the thickness of the central portion 22 is 20 μm or more, the arithmetic mean height Sa of the central portion 22 is less than that of the peripheral portion 21 and 1 μm or more. Accordingly, the surface of central portion 22, which is the closest to substrate 2a when the coil component 1 is mounted on the substrate 2a has a high surface smoothness. Therefore, the position of coil component 1, such as the distance and inclination of the coil component 1 relative to the substrate 2a, is stable, thereby enabling more accurate and high-density mounting.

### Other Embodiments

Other embodiments of the present invention will be described below. The explanation below will focus on differences from the first embodiment, and elements that are the same or similar in the first embodiment will be identified with the same reference symbols and redundant explanation will be omitted.

FIG. 6 is a bottom view of a coil component according to a second embodiment of the present invention.

In the second embodiment, the external electrodes 12 are located away from the peripheries of the bottom face 1d. That is, each external electrode 12 does not reach the corresponding end face 1a or 1b, the front face 1e, and the rear face 1f. The arrangement of the external electrodes 12 shown in FIG. 6 facilitates the mounting solder to be located within the contour of the bottom face 1d, resulting in contributing to high-density mounting.

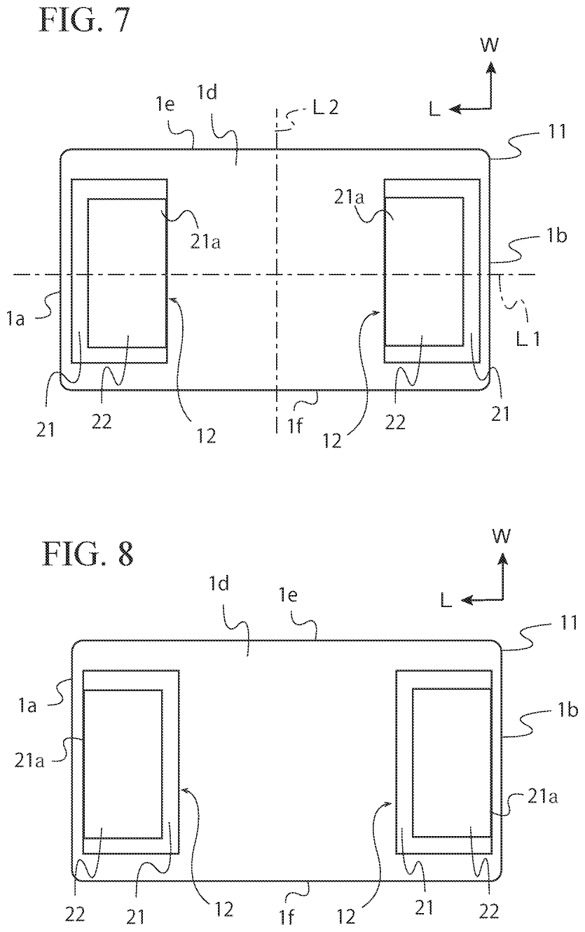

FIG. 7 is a bottom view of a coil component according to a third embodiment of the present invention.

In the third embodiment, the peripheral portion 21 of each external electrode 12 does not surround the corresponding central portion 22, and has an opening 21a. The openings 21a of the peripheral portions 21 face each other, so that there is no portion of the peripheral portions 21 between the central portions 22 of the pair of external electrodes 12. Also in the third embodiment, the central portions 22 and the peripheral portions 21 of the pair of external electrodes 12 are symmetrically positioned. That is, the central portions 22 are symmetrical with respect to a symmetry axis L1 extending in the L direction. The same is true for the peripheral portions 21. The central portions 22 and peripheral portions 21 are also arranged symmetrically with respect to the symmetry axis L2 extending in the W direction.

FIG. 8 is a bottom view of a coil component according to a fourth embodiment of the present invention.

In the fourth embodiment, in contrast to the third embodiment shown in FIG. 7, the peripheral portions 21 have openings 21a oriented opposite to each other (each opening 21a of the peripheral portion 21 faces the neighboring end face 1a or 1b), so that there are portions of the peripheral portions 21 between the central portions 22 of the pair of external electrodes 12. In both the third and fourth embodiments, the coil component 1 has a sufficient stability and mechanical strength that are suitable for mounting on the substrate 2a. In particular, in the third and fourth embodiments, the coil component 1 can be made smaller by partial forming of the peripheral portions 21.

Dimensions of each portion in the coil component 1 can be determined by cross-sectional observation. For example, the thickness of the external electrode 12 is determined with respect to the first face (bottom face 1d) of the magnetic base body 11, and is measured in the direction perpendicular to the first face. If the first face is constituted of different planes or includes a surface waviness, each dimension is obtained by measuring multiple points and by averaging the measured values. The surface roughness is also obtained by cross-sectional observation.

Although each external electrode 12 is disposed on the first face (bottom face 1d) only, each external electrodes 12 may have a portion disposed on the first face and another portion disposed on another face that is adjacent to and is perpendicular to the first face. Those portions are integral with each other.

The use of the coil component 1 is not limited to a high-density mounting application. The coil component 1 may also be used for substrate mounting, resin molding, or substrate embedding other than high-density mounting applications.

The present invention has been shown and described with reference to preferred embodiments thereof. However, it will be understood by those skilled in the art that various changes in form and detail may be made without departing from the scope of the invention as defined by the claims. Such variations, alterations, and modifications are intended to be encompassed in the scope of the present invention.

What is claimed is:

1. A coil component comprising:
a magnetic base body including magnetic metal particles and resin;
a conductor disposed inside or on a face of the magnetic base body; and
external electrodes disposed on a first face of the magnetic base body and connected with the conductor, each external electrode having a central portion and a peripheral portion disposed adjacent to the central portion, the central portion having a contact surface that is in contact with the first face and an exterior surface that is opposite to the contact surface, the peripheral portion having a contact surface that is in contact with the first face and an exterior surface that is opposite to the contact surface, wherein a distance from the first surface to the exterior surface of the peripheral portion is less than a distance from the first surface to the exterior surface of the central portion.

2. The coil component according to claim 1, wherein the peripheral portion surrounds the central portion in each of the external electrodes.

3. The coil component according to claim 1, wherein the central portion has multiple layers stacked one on top of another, and the peripheral portion has multiple layers stacked one on top of another, and wherein a number of layers in the central portion is greater than a number of layers in the peripheral portion in each of the external electrodes.

4. The coil component according to claim 3, wherein each of the external electrodes has a metal layer commonly provided to the exterior surfaces of the central portion and the peripheral portion, and the central portion has a resin layer between the metal layer and the first face in each of the external electrodes.

5. The coil component according to claim 1, wherein the external electrodes are located within an area of the first face.

6. The coil component according to claim 1, wherein the exterior surface of the peripheral portion has a surface roughness that is greater than a surface roughness of the exterior surface of the central portion in each of the external electrodes.
